(19) United States
(12) Patent Application Publication
(10) Pub. No.: US 2012/0294698 A1
(43) Pub. Date: Nov. 22, 2012

(54) DELIVERY SYSTEM

(76) Inventor: Daniel Villamar, Las Vegas, NV (US)

(21) Appl. No.: 13/415,826

(22) Filed: Mar. 8, 2012

Related U.S. Application Data
(60) Provisional application No. 61/519,230, filed on May 18, 2011.
(60) Provisional application No. 61/629,837, filed on Nov. 29, 2011.
(60) Provisional application No. 61/630,541, filed on Dec. 14, 2011.

(51) Int. Cl. B65G 67/02; B61B 13/00

(52) U.S. Cl. 414/392; 104/140

(57) ABSTRACT

A delivery system includes a delivery vehicle configured to ride along a flat track. The delivery vehicle includes a guiding pin. The guiding pin is configured to interlock with a guiding groove.

### CROSS-REFERENCE TO RELATED APPLICATIONS

The present Utility patent application claims priority benefit of the U.S. provisional application for patent Ser. Nos. 61/519,230, filed on May 18 2011, titled “Automated Delivery System, 61/629,837, filed on Nov. 29, 2011, titled “Automated Delivery System, and 61/630,541”, filed on Dec. 14 2011, titled “Automated Delivery System under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to delivery systems. More particularly, one or more embodiments of the invention relate to automated delivery systems.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically items are delivered in vehicles such as conventional automobiles and aircraft. These items are usually loaded onto such vehicles manually by humans. These vehicles sometimes cause traffic congestion. Additionally, these vehicles are typically powered by pollutants, including fossil fuels.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary automated delivery system, in accordance with an embodiment of the present invention; and

FIG. 2 illustrates another exemplary automated delivery system, in accordance with an embodiment of the present invention;

FIG. 3 illustrates another exemplary automated delivery system, in accordance with an embodiment of the present invention; and

FIG. 4 is a block diagram depicting an exemplary client/server system which may be used by an exemplary web-enabled/networked embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), uselat r datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se; i.e., where the medium itself is transitory.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A practical embodiment of an automated delivery system may include a delivery vehicle, Some embodiments may include a guiding groove, a guiding pin, a flat track, a groove break, a groove ledge, a guiding pin track, a track break, a duel use wheel, a turn counting system, a rotating guiding pin, a cargo kart, or a placer robot. In many practical embodiments the delivery vehicle may be tiny and light weight. In some embodiments the delivery vehicle may be used in conjunction with the Automated Delivery System infrastructure.

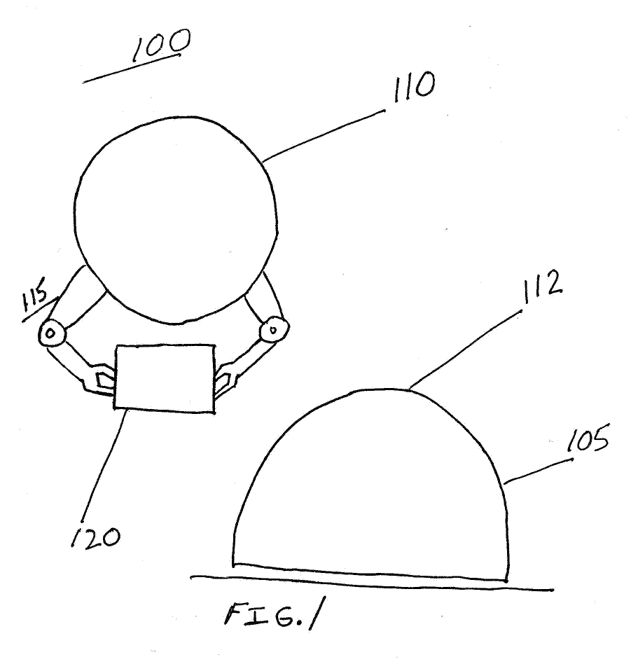

FIG. 1 illustrates an exemplary automated delivery system, in accordance with an embodiment of the present invention. Referring initially to FIG. 1, an automated delivery system 100 includes a delivery vehicle 105. In some alternative embodiments, the delivery vehicle may be small or lightweight. Suitable weight ranges for the delivery vehicle include, but are not limited to 15 pounds through 300 pounds. In some embodiments the delivery vehicle weight may be in the range of 300 pounds through 10,000 pounds. Suitable materials for the delivery vehicle include, but are not limited to metal, plastic, rubber, steel, aluminum, fiberglass, at least one polymer, a composite material, and combinations thereof. In the present embodiment of the present invention, the delivery vehicle may include a void 112. In yet another embodiment, the delivery vehicle may be configured to move between various types of buildings, including but not limited to, grocery stores, factories, homes, offices, and warehouses. In some embodiments, the delivery vehicle may be a flying vehicle. Another embodiment of the present invention provides a placer robot 110. Suitable weight ranges for the placer robot include, but are not limited to 4 pounds through 85 pounds. In some embodiments, the placer robot weight may be in the range of 80 pounds to 3,000 pounds. Suitable materials for the placer robot include, but are not limited to metal, plastic, rubber, steel, aluminum, fiberglass, at least one polymer, a composite material, and combinations thereof. In some alternative embodiments of the present invention, the placer robot may include an arm 115. In another embodiment the placer robot 110 is configured to work in conjunction with the delivery vehicle 105 to load the delivery vehicles with an item 120. In some alternative embodiments the placer robot may include a measuring device. Suitable measuring devices include, but are not limited to, a laser, a SONAR, a stereo camera, and a sensor. In some alternative embodiments the measuring device is configured to take measurements regarding the positioning and distance of the item. In the present embodiment, the placer robot 110 is configured to pick up the item 120 and place the item into the void 112. In some alternative embodiments the arm 115 is configured to pick up the item 120 and place the item into the void 112. In some embodiments, the automated delivery system may be configured to transport passengers.

In the present embodiment of the present invention, the placer robot is configured to interact with a computer. In another embodiment the placer robot is configured to use a sensor to take measurements so that it knows the distance and positioning of the item. Suitable sensors include, but are not limited to a laser, LIDAR “Light Dectection and Ranging”, sonar, a global positioning system, an infrared sensor, an ultra sonic range finder, RADAR “Radio Detection and Ranging”, and combinations thereof. In yet another embodiment the placer robot is to be powered by a device including, but not limited to a motor, a gear, a wire, a wheel, an actuator, and combinations thereof. In other alternative embodiments the computers is configured to control the movements and functions of the delivery vehicles and placer robots.

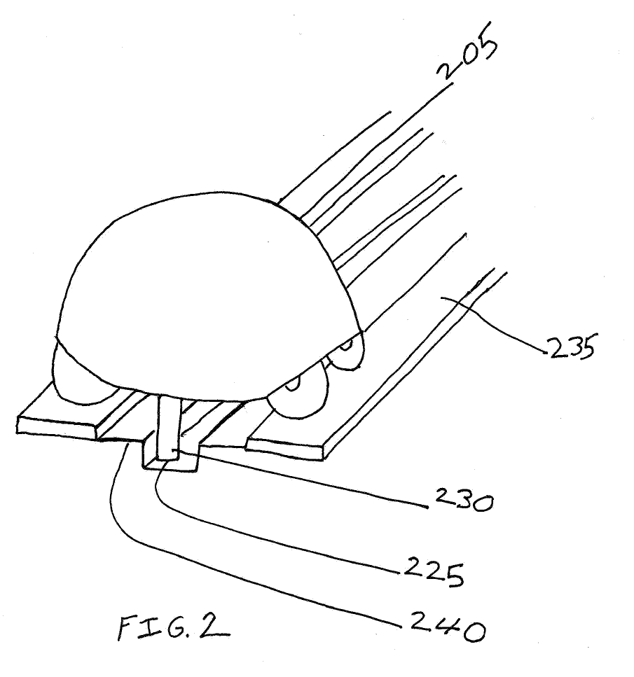

FIG. 2 illustrates another exemplary automated delivery system, in accordance with an embodiment of the present invention. Referring to FIG. 2, the present embodiment of the present invention may include a guiding groove 225 configured as a slit in a roadway. In some alternative embodiments, the guiding groove is configured to act as a guide way that allows the delivery vehicle to stay on track and move steadily in a direction. In other alternative embodiments the guiding groove may be located along the length of a tunnel ceiling, or on the top of a road surface. In other alternative embodiments the plurality of guiding grooves may be located adjacent to each other. The guiding groove can extend into a straight line or curve. Suitable materials for the guiding groove include, but are not limited to, metal, plastic, rubber, steel, copper, aluminum, concrete, asphalt, asphalt concrete or polished concrete.

In the present embodiment of the present invention, the delivery vehicle may include a guiding pin 230. Suitable shapes for the guiding pin include, but are not limited to a spindle, a cone, a pyramid, a sphere, a cube, a cylinder, a nail shape, and a tubular. Suitable materials for the guiding pin include, but are not limited to, metal, plastic, rubber, steel, copper, aluminum, concrete, polished concrete, fiberglass, at least one polymer, a composite material, and combinations thereof. One or more than one guiding pin may extend from a vehicle. In some embodiments, at least a portion of the guiding groove may be covered by a material metal material including, but are not limited to, metal, plastic, rubber, steel, copper, aluminum, concrete, polished concrete, fiberglass, at least one polymer, a composite material, and combinations thereof. In some alternative embodiments the guiding pin 230 is configured to interlock with the guiding groove 225 and keep the delivery vehicle in place.

The present embodiment of the present invention provides a flat track 235. In another embodiment the flat track is configured as a surface. In the present embodiment the delivery vehicle 205 is configured to ride along the flat track. In some alternative embodiments, friction is decreased on the flat track. Suitable materials for the flat track include, but are not limited to, metal, plastic, rubber, steel, copper, aluminum, concrete, polished concrete, fiberglass, at least one polymer, a composite material, and combinations thereof. In some alternative embodiments, the flat track 235 may be at least partially embedded into a road surface. In some alternative embodiments the flat track includes a width. Suitable widths for the flat track include, but are not limited to 1 centimeter through 6 inches. In some alternative embodiments the flat track includes a thickness. Suitable thicknesses for the flat track include, but are not limited to 1 millimeter through 4 inches. In some embodiments, the thickness of the flat track may be in the range of 4 inches through 6 inches. In some alternative embodiments the flat track includes a thickness. Suitable thicknesses for the flat track include, but are not limited to 1 millimeter through 4 inches. In the present embodiment of the present invention, a plurality of flat tracks are provided. In some embodiments, the flat track may be configured to join to the guiding groove. In many embodiments, the flat track may be configured to join to a guiding pin track.

The present embodiment of the present invention provides a groove break. In another embodiment the groove break is attached to the delivery vehicle. In some embodiments the groove break may extends from a bottom of the delivery vehicle. In another embodiment the groove break is configured to slow and stop the delivery vehicle. In some alternative embodiment the groove break may be disposed within the guiding groove. In other alternative embodiments the groove break may extend downward from the delivery vehicle and grip a conventional protruding track. Suitable shapes for the groove break include, but are not limited to spindle, a cone, a pyramid, a sphere, a cube, any type of disk break, oval, kidney shaped, circular, square, or rectangular.

The present embodiment of the present invention provides a groove ledge 240. In another embodiment the groove ledge may be a continuous two sided wall. In yet another embodiment, the groove ledge may be disposed within the guiding groove 225. In some alternative embodiments the groove ledge is configured to be gripped by the groove break to slow the delivery vehicle 205. Suitable shapes for the groove ledge include, but are not limited to spindle, a cone, a pyramid, a sphere, a cube, a rectangle, a triangle, a square, and an “L” shape. In some embodiments, the groove ledge may be located between a plurality of guiding grooves. Suitable materials for the groove ledge include, but are not limited to, metal, plastic, rubber, steel, copper, aluminum, concrete, fiberglass, at least one polymer, a composite material, polished concrete, and combinations thereof.

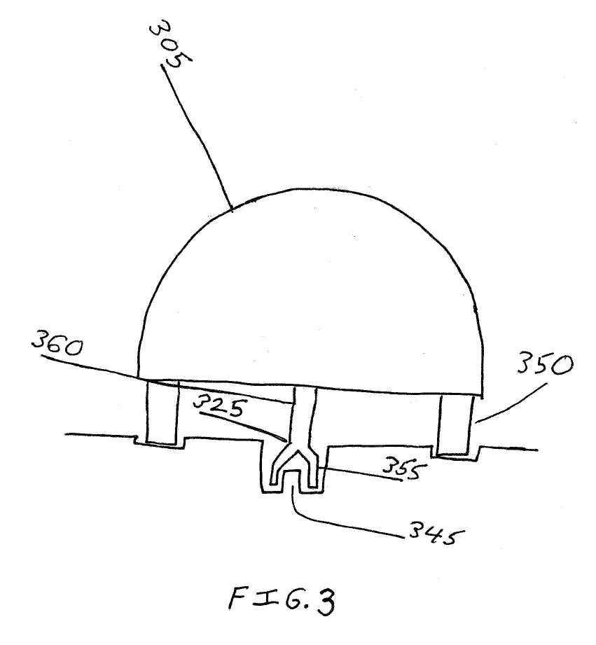

FIG. 3 illustrates another exemplary automated delivery system, in accordance with an embodiment of the present invention. Referring to FIG. 3, the present embodiment of the present invention provides a guiding pin track 345. In another embodiment the guiding pin track is configured as a curved wall. In yet another embodiment a plurality of guiding pin tracks are positioned across from each other in parallel. In some alternative embodiments, the guiding pin track 325 protrudes slightly from a surface. In other alternative embodiments, a channel is provided which extends down the length of the guiding pin track. Suitable shapes for the guiding pin track include, but are not limited to a half pipe, at least one quarter oval. In some embodiments, a slit is disposed in the guiding pin track. The slit may be disposed between a plurality of sides of the guiding pin track. Suitable materials for the guiding pin track include, but are not limited to, metal, plastic, rubber, steel, copper, aluminum, concrete, polished concrete, fiberglass, at least one polymer, a composite material, and a combination thereof.

The present embodiment of the present invention provides a duel use wheel 350. In another embodiment the dual use wheel includes a thick wheel lip. Suitable materials for the wheel lip include, but are not limited to, metal, plastic, rubber, steel, copper, aluminum, concrete, polished concrete, fiberglass, at least one polymer, a composite material, and combinations thereof. In some embodiments, the dual use wheel is attached to the delivery vehicle 305. Suitable materials for the dual use wheel include, but are not limited to, metal, plastic, rubber, steel, copper, aluminum, concrete, polished concrete, fiberglass, at least one polymer, a composite material, and combinations thereof.

The present embodiment of the present invention provides a track break 355. In another embodiment the track break may be a flat bar shaped object which extends from the delivery vehicle 305. In yet another embodiment the track break 355 is configured to move outward or inward and press against the sides of a surface to slow the delivery vehicle. In some alternative embodiments a rotating motor driven gear is provided. In other alternative embodiments a rack gear is provided. Suitable materials for the track break include, but are not limited to, metal, plastic, rubber, steel, copper, aluminum, concrete, polished concrete, fiberglass, at least one polymer, a composite material, and combinations thereof. In some embodiments, the track break may be configured to guide the delivery vehicle. Suitable shapes for the guide break include, but are not limited to, a square, a cube, an “L” shape, and a “C” shape. In some embodiments, the track break may include a wheel. The wheel may be configured to roll against the guiding groove.

The present embodiment of the present invention includes a turn counting system. In another embodiment, sensors are placed along the flat track. In some alternative embodiments, the turn counting system allows the delivery vehicle to know when to turn by counting and remembering the number of turns that it passes before taking the desired turn. In other alternative embodiments a computer is configured to count the turns as the delivery vehicle passes each turn. In some alternative embodiments, sensors may be placed near the turns. Suitable sensors include, but are not limited to lasers, light detection sensors, ranging sensors, and radio detection sensors. In some embodiments, the turn counting system includes a button located on the delivery vehicle. A mechanism near or at a turn may be configured to contact the button. A turn may be counted when the button is contacted. In some embodiments, a laser may be joined to the delivery vehicle. The laser may be disposed in the guiding groove. An indicator may be located in the guiding groove. A turn may be counted when the indicator is detected by the laser. In some embodiments, the laser may be removably joined to the guiding pin. In other embodiments, the laser may be removably joined to a rotating guiding pin.

The present embodiment of the present invention may include a rotating guiding pin 360. In another embodiment the rotating guiding pin includes a plurality of ends. In yet another embodiment the rotating guiding pin 360 may include an axle which including a disk shaped head on each ends. In some alternative embodiments the rotating guiding pin includes a tube configured as a ring shaped head. In another embodiment the ring shaped head has a circumference. Suitable circumferences include, but are not limited to a range of ½ inch through 4 inches. In yet another embodiment the tube includes a circumference. Suitable circumferences include, but are not limited to a range of 1 centimeter through 4 inches. In some alternative embodiments, the guiding pin includes a body configured as a nail with a blunted tip. In other alternative embodiments the axle fits through a disposed in the body. In the present embodiment of the present invention the rotating guiding pin is configured to rotate if it comes into contact with a guiding groove. Suitable shapes for the axle include, but are not limited to nail shaped, and cylindrical.

The present embodiment of the present invention includes a cargo kart. In another embodiment the cargo kart is configured to transport the item from a first place to a second place. Suitable shapes for the cargo kart include, but are not limited to, bullet train shaped, cylinder shaped, rectangular box shaped, and bullet shaped. Suitable materials for the cargo kart include, but are not limited to, metal, plastic, rubber, steel, copper, aluminum, concrete, polished concrete, fiberglass, at least one polymer, a composite material, and combinations thereof In some alternative embodiments, the cargo kart is configured to attach to the delivery vehicle. In other alternative embodiments, the cargo kart is configured to transfer the item from the cargo kart to the delivery vehicle. In some embodiments, the cargo kart may include at least one row of wheels. In many embodiments, the cargo kart may include a guiding pin.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

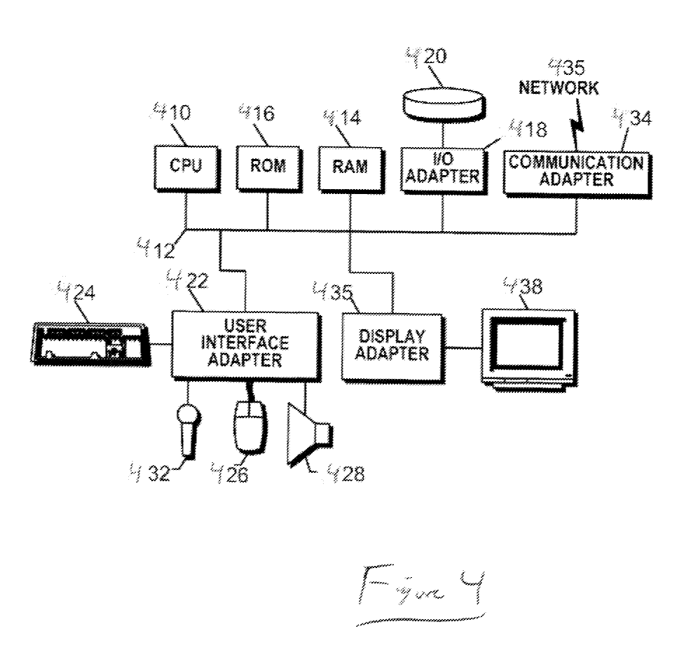

FIG. 4 is a block diagram depicting an exemplary client/server system which may be used by an exemplary web-enabled/networked embodiment of the present invention.

A communication system 400 includes a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate bi-directionally with local network 406 via a communication channel 416. Client 404 may communicate bi-directionally with local network 408 via a communication channel 418. Local network 406 may communicate bi-directionally with global network 410 via a communication channel 420. Local network 408 may communicate bi-directionally with global network 410 via a communication channel 422. Global network 410 may communicate bi-directionally with server 412 and server 414 via a communication channel 424. Server 412 and server 414 may communicate bi-directionally with each other via communication channel 424. Furthermore, clients 402, 404, local networks 406, 408, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WANs), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 436, mass memory storage 438, GUI 940, video camera 442, input/output interface 444 and network interface 446 may communicate in a unidirectional manner or a bi-directional manner with each other via a communication channel 448. Communication channel 448 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 926 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC § 112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of an automated delivery system according to the present invention will be apparent to those skilled in the art. The invention has been described above by way of illustration, and the specific embodiments disclosed are not intended to limit the invention to the particular forms disclosed. For example, the particular implementation of the automated delivery system may vary depending upon the particular type delivery vehicle used. The delivery vehicles described in the foregoing were directed to automated implementations; however, similar techniques are contemplated including manual operation within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A delivery system comprising:
a delivery vehicle being configured to ride along a flat track, the delivery vehicle comprising a guiding pin, and the guiding pin being configured to interlock with a guiding groove.

2. The delivery system of claim 1, further comprising a groove ledge being disposed within the guiding groove, the groove ledge being configured to be gripped by the groove break, said groove break being operable to slow the delivery vehicle.

3. The delivery system of claim 1, in which the flat track comprises metal; and
the flat track is at least partially embedded in a road surface.

4. The delivery system of claim 1, further comprising a groove break, said groove break being configured to slow the delivery vehicle, in which the groove break is disposed within the guiding groove.

5. The delivery system of claim 4, in which the groove break is joined to the delivery vehicle.

6. The delivery system of claim 1, further comprising a track break; the track break joined to the delivery vehicle; and the track break being configured to press against a side of a surface to slow the delivery vehicle.

7. The delivery system of claim 1, further comprising a placer robot, the placer robot comprising an arm, the arm being configured to load an item onto the delivery vehicle.

8. The delivery system of claim 7, in which the placer robot further comprises a measuring device, the measuring device being configured to measure a position of the item.

9. The delivery system of claim 1, further comprising a turn counting system.

10. The delivery system of claim 9, in which the turn counting system comprises a button joined to the delivery vehicle, the button being configured to contact a mechanism, the mechanism being configured to count a turn when the button is contacted.

11. The delivery system of claim 10, in which the turn counting system comprises a laser, the laser joined to the delivery vehicle, the laser being configured to detect an indicator being disposed in the guiding groove, the laser further being configured to count a turn when the indicator is detected.

12. An automated delivery system comprising:
a client, said client being configured to communicate with a delivery vehicle;
the delivery vehicle being configured to ride along a flat track, the delivery vehicle comprising a guiding pin, the guiding pin being configured to interlock with a guiding groove;
a groove break being configured to slow the delivery vehicle; and
a groove ledge being disposed within the guiding groove, the groove ledge being configured to be gripped by the groove break to slow the delivery vehicle.

13. The delivery system of claim 12, further comprising a track break; the track break joined to the delivery vehicle; and the track break being configured to press against a side of a surface to slow the delivery vehicle.

14. The delivery system of claim 12, further comprising a placer robot, the placer robot comprising an arm, the arm being configured to load an item onto the delivery vehicle.

15. The delivery system of claim 12, further comprising a turn counting system.

16. The delivery system of claim 15, in which the turn counting system comprises a button joined to the delivery vehicle, the button being configured to contact a mechanism, the mechanism being configured to count a turn when the button is contacted.

17. The delivery system of claim 15, in which the turn counting system comprises a laser, the laser joined to the delivery vehicle, the laser being configured to detect an indicator being disposed in the guiding groove, the laser further being configured to count a turn when the indicator is detected.

18. An automated delivery system comprising a delivery vehicle; a client; a flat track; a means for transporting an item between buildings; a means for communicating between the delivery vehicle and the client; a means for guiding the delivery vehicle along the flat track; and a means for slowing the delivery vehicle.

19. The automated delivery system of claim 18, further comprising a placer robot; and a means for the placer robot to place the item on the delivery vehicle.

20. The automated delivery system of claim 18, further comprising a button joined to the delivery vehicle; a mechanism; a means for the mechanism to contact the button; and a means for counting a turn when the button is contacted.
